(19) United States
(12) Patent Application Publication
(10) Pub. No.: US 2006/0017366 A1
(43) Pub. Date: Jan. 26, 2006

(54) Low-pressure mercury vapor discharge lamp

(75) Inventors: Rene Jan Hendriks, Eindhoven (NL); Ingrid Jozef Maria Snijkers-Hendrickyx, Eindhoven (NL); Remy Cyrille Broersma, Mainvilliers (FR); Hendrik-Jan Dreuning, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/531,940

(22) PCT Filed: Sep. 26, 2003
(86) PCT No.: PCT/IB03/04273

§ 371 Date: Apr. 19, 2005

(30) Foreign Application Priority Data
Oct. 23, 2002 (EP) 02079418.6

(51) Int. Cl. H01J 1/62; H01J 61/35; H01J 17/16

(52) U.S. Cl. 313/489; 313/635

(57) ABSTRACT

The low-pressure mercury vapor discharge lamp has a light-transmitting discharge vessel (10), enclosing a discharge space (13) provided with mercury and a rare gas and comprising means for maintaining a discharge in the discharge space. At least a part of the discharge vessel is provided with a luminescent layer (17) of a luminescent material. At least an outer portion of the discharge vessel is provided with a coating (3). According to the invention, the coating comprises a pigment which absorbs part of the visible light and/or the coating comprises reflecting particles. The coating comprises a network obtainable through conversion of an organically modified silane by means of a sol-gel process. The organically modified silane is selected from the group formed by compounds of the structural formula RISi(ORII)3, wherein RI is an alkyl group or an aryl group and RII is an alkyl group.

The invention relates to a low-pressure mercury vapor discharge lamp comprising a light-transmitting discharge vessel,

the discharge vessel enclosing, in a gastight manner, a discharge space provided with a filling of mercury and a rare gas,

the discharge vessel comprising means for maintaining a discharge in the discharge space,

at least a portion of the discharge vessel being provided with a luminescent layer of a luminescent material,

at least a portion of the discharge vessel facing away from the discharge space being provided with a coating.

In mercury vapor discharge lamps, mercury constitutes the primary component for the (efficient) generation of ultraviolet (UV) light. A luminescent layer comprising a luminescent material may be present on an inner wall of the discharge vessel to convert UV to other wavelengths, for example to UV-B and UV-A for tanning purposes (sun panel lamps) or to visible radiation for general illumination purposes. Such discharge lamps are therefore also referred to as fluorescent lamps. In an alternative embodiment of the low-pressure mercury vapor discharge lamp, the fluorescent layer is provided on the side of the discharge vessel facing away from the discharge space. Alternatively, the ultraviolet light generated may be used for manufacturing germicidal lamps (UV-C). The discharge vessel of low-pressure mercury vapor discharge lamps is usually circular and comprises both elongate and compact embodiments. Generally, the tubular discharge vessel of compact fluorescent lamps comprises a collection of relatively short straight parts having a relatively small diameter, which straight parts are connected together by means of bridge parts or via bent parts. Compact fluorescent lamps are usually provided with an (integrated) lamp cap. Normally, the means for maintaining a discharge in the discharge space are electrodes arranged in the discharge space. In an alternative embodiment the low-pressure mercury vapor discharge lamp comprises a so-called electrodeless low-pressure mercury vapor discharge lamp.

A low-pressure mercury vapor discharge lamp of the type mentioned in the opening paragraph is known from the English abstract of JP-A 62 272 449. In the case of the known low-pressure mercury vapor discharge lamp, a coating is applied to an outer surface of the discharge vessel, which coating comprises a yellow organic pigment. In particular, the coating suppresses radiation of 500 nm or less.

For the application of said coatings, use is generally made of organic lacquers. The organic lacquer forms a kind of carrier matrix containing the pigment or the dye. Said organic lacquer coatings normally show a relatively bad adhesion to the discharge vessel. In the known lamp, the yellow organic pigment is added to a fluorine resin so as to form a paint. A hardening agent is added to the paint, which is diluted with xylene and butyl acetate in order to obtain the coating on the outside of a fluorescent lamp. In an alternative route, the paints are applied to by means of dip coating. In an alternative embodiment, a lacquer of a polyester silicone is applied to the discharge vessel by means of a spraying process.

It is a drawback of the known low-pressure mercury vapor discharge lamp comprising a coating on the basis of an organic pigment that the adhesion of the coating to the discharge vessel deteriorates substantially and/or the organic pigments degrade at higher temperatures. Since the dimensions of the luminaires accommodating the low-pressure mercury vapor discharge lamp decrease continuously, as do the dimensions of the low-pressure mercury vapor discharge lamp itself, the temperature of the discharge vessel provided with the coating rises. In addition, there is a trend towards further miniaturization, so that the discharge vessel provided with the coating reaches even higher temperatures, normally as a consequence of an increased wall load.

It is an object of the invention to eliminate the above drawback wholly or partly. According to the invention, a low-pressure mercury vapor discharge lamp of the kind mentioned in the opening paragraph is for this purpose characterized in that

the coating comprises a pigment which absorbs a part of the visible or UV light and/or the coating comprises reflecting particles,

the coating comprises a network obtainable through conversion of an organically modified silane by means of a sol-gel process,

said organically modified silane being selected from the group formed by compounds of the following structural formula: R^{I}Si(OR^{II})₃,

wherein R^{I} represents an organic group, preferably an alkyl group or an aryl group, and

wherein R^{II} represents an alcyl group.

Replacing the organic lacquer in the coating in the known low-pressure mercury vapor discharge lamp with a network comprising an organically modified silane as the starting material leads to an optically transparent, non-scattering, coating which can resist high temperatures (up to 400° C.). Owing to the use of an organically modified silane in the manufacture of the network, a proportion of the R^{I} groups, i.e. the alkyl or aryl groups, remains present so as to form end groups in the network. As a result, instead of four network bonds per Si atom, the network in accordance with the invention has fewer than four network bonds per Si atom. A network which is partly composed of said alkyl or aryl groups has a greater elasticity and flexibility than the customarily used silica network. This enables relatively thick coatings to be manufactured.

An advantage of the application of a coating on the low-pressure mercury vapor discharge lamp in addition to a fluorescent layer is that a discharge vessel with a standard fluorescent layer can be used and that the coating is used to modify the color (temperature) of the low-pressure mercury vapor discharge lamp, i.e. by making it suitable for use in an environment where certain types of light are not allowed, for instance by suppressing radiation below 500 nm in e.g. clean room environments which should be exempt of UV-light. The low-pressure mercury vapor discharge lamp can be made diffusely reflective, the reflector being integrated in the fluorescent lamp, in that a coating with reflecting particles is applied partly on the outer surface of the discharge vessel.

An advantage of changing the color temperature is that light can be produced with higher color saturation. In addition, the lumen maintenance of the low-pressure mercury vapor discharge lamp is improved because the pigments are no longer in contact with the mercury discharge. An advantage of providing a reflecting coating on the outer surface of the discharge vessel is that the light emitted by the low-pressure mercury vapor discharge lamp can be emitted in a bundle-like shape. The wall thickness of the glass of the discharge vessel can be decreased, lowering the cost price of the discharge vessel, in that a strengthening and/or scratch resistant coating is applied on the outside of the discharge vessel.

Preferably, the R^{I} group comprises CH₃ or C₆H₅. These substances have a relatively good thermal stability. A network comprising methyl or phenyl groups enables thicker coatings to be obtained. Experiments have further shown that coatings wherein methyl or phenyl groups are incorporated in a network are stable up to a temperature of at least 350° C. Said groups are end groups in the network and remain part of the network at said higher temperatures. At such a relatively high temperature load on the coating, no appreciable degradation of the network occurs during the service life of the low-pressure mercury vapor discharge lamp. In an alternative embodiment, R^{I} comprises an organic group in the form of an epoxy-amino group. Since the operational temperature and the UV output of fluorescent lamps are relatively low, such coatings can be applied and are stable during the operational life of the discharge lamp.

Preferably, the R^{II} group comprises CH₃ or C₂H₅. Methyl and ethyl groups are particularly suitable because methanol and ethanol are formed in the hydrolysis process. Said substances are compatible with the pigment dispersion and evaporate relatively easily. In general, the methoxy groups (—OCH₃) react more rapidly than the ethoxy groups (—OC₂H₅) which, in turn, react more rapidly than (iso)propoxy groups (—OC₃H₇). For a smooth hydrolysis process, use is advantageously made of R^{II} groups which are not very long.

Very suitable starting materials for the manufacture of the network in accordance with the invention are:
methyltrimethoxy silane (MTMS), where R^{I}═R^{II}═CH₃,
methyltriethoxy silane (MTES), where R^{I}═CH₃ and R^{II}═C₂H₅,
phenyltrimethoxy silane (PTMS), where R^{I}═C₆H₅ and R^{II}═CH₃, and
phenyltriethoxy silane (PTES), where R^{I}═C₆H₅ and R^{II}═C₂H₅.
   Such starting materials are known per se and commercially available.

An embodiment of the low-pressure mercury vapor discharge lamp in accordance with the invention is characterized in that the thickness t_{c} of the coating is t_{c}≧1 μm. If use is made of a network composed of silica, which comprises four network bonds per Si atom, the thickness of the coating is limited to approximately at most 0.5 μm under atmospheric conditions. If such silica layers have a greater thickness exceeds said thickness, stress in the layer readily leads to cracks and/or the coating readily becomes detached from the discharge vessel. A much greater layer thickness can be attained when a network comprising fewer than four network bonds per Si atom is used. Preferably, t_{c}≧2 μm. In thicker coatings, more pigment or dye can be incorporated, whereby the color effect of the coating is improved.

Inorganic filling materials may be incorporated in the coating. For this purpose, silica particles having a diameter d≦50 nm are incorporated in the network in a favorable embodiment of the low-pressure mercury vapor discharge lamp in accordance with the invention. Incorporation of these so-called nano-sized silica particles reduces shrinkage of the layer during the manufacture thereof. In addition, the incorporation of said nano-sized silica particles makes it possible to obtain even thicker coatings which bond well to the discharge vessel. 20 μm thick layers having favorable bonding properties can be obtained through the addition of nano-sized silica particles to a network, wherein alkyl or aryl groups, which form the R^{I} groups, are present as the end groups. Such thick layers can contain considerable quantities of a pigment or a dye to obtain the desired color point of the coating.

Incorporation of said silica particles renders it possible to manufacture coatings in a greater thickness. The refractive index of such a coating is less influenced by the refractive index of the pigment when the same quantity of pigment is incorporated in a thicker coating. The use of said silica particles thus results in a certain degree of freedom to bring the refractive index of the coating to a desired value and maintain the refractive index at said value.

Inorganic pigments are preferably used for the manufacture of coatings having the desired optical properties and having the desired thermal stability during the service life of the low-pressure mercury vapor discharge lamp. In a favorable embodiment of the low-pressure mercury vapor discharge lamp in accordance with the invention, the pigment is selected from the group formed by iron oxide, iron oxide doped with phosphorus, zinc-iron oxide, cobalt aluminate, neodymium oxide, bismuth vanadate, zirconium-praseodymium silicate, or mixtures thereof. Iron oxide (Fe₂O₃) is an orange pigment and P-doped Fe₂O₃ is an orange-red pigment. Zinc-iron oxide, for example ZnFe₂O₄ or ZnOZnFe₂O₄ is a yellow pigment. Mixing (P-doped) Fe₂O₃ with ZnFe₂O₄ yields a pigment of a deep orange color. Cobalt aluminate (CoAl₂O₄) and neodymium oxide (Nd₂O₅) are blue pigments. Bismuth vanadate BiVO₄), also referred to as pucherite, is a yellow-green pigment. Zirconium-praseodymium silicate is a yellow pigment. Experiments have shown that a network including said inorganic pigments does not appreciably degrade during lamp life and at the relatively high temperature load on the coating.

In an alternative, preferred embodiment of the low-pressure mercury vapor discharge lamp according to the invention, coatings are obtained wherein organic pigments are used. Particularly suitable pigments are the so-called Red 177 (anthraquinone) or chromium phthalic yellow or chromium phthalic red from “Ciba”. Further suitable pigments are Red 149 (perylene), Red 122 (quinacridone), Red 257 (Ni-isoindoline), Violet 19 (quinacridone), Blue 15:1 (Cu-phthalocyanine), Green 7 (hal.Cu-phthalocyanine), and Yellow 83 (dyaryl) from “Clariant”.

Amber-colored chromophtal yellow, chemical formula C₂₂H₆C₁₈N₄O₂ and C.I. (constitution number) 56280, is an organic dye and is also referred to as “C.I.-110 yellow pigment”, “C.I. pigment yellow 137”, or Bis[4,5,6,7-tetrachloro-3-oxoisoindoline-1-ylidene)-1,4-phenylenediamine. Amber-colored anthraquinone, chemical formula C₃₇H₂₁N₅O₄ and C.I. 60645, is an organic dye and is also referred to as “Filester yellow 2648A” or “Filester yellow RN”, chemical formula 1,1′-[(6-phenyl-1,3,5-triazine-2,4diyl)diimino]bis-. Red-colored “chromophtal red A2B” with C.I. 65300 is an organic dye and is alternatively referred to as “pigment red 177”, dianthraquinonyl red, or as [1,1′-Bianthracene]-9,9′,10,10′-tetrone, 4,4′-diamino-(TSCA, DSL).

Mixtures of inorganic and organic pigments are also suitable, for example a mixture of chromium phthalic yellow and (zinc)iron oxide.

An alternative embodiment of the low-pressure mercury vapor discharge lamp in accordance with the invention is characterized in that the pigment causes a change in the color temperature of the low-pressure mercury vapor discharge lamp. For example, the application of a coating of the blue pigment cobalt aluminate (CoAl₂O₄) or neodymium oxide (Nd₂O₅) raises the color temperature of the low-pressure mercury vapor discharge lamp.

A preferred embodiment of the low-pressure mercury vapor discharge lamp according to the invention is characterized in that the reflecting particles are selected from the group formed by aluminum, silver, aluminum oxide, titanium oxide, and barium sulfate.

Preferably, an average diameter dₚ of the pigment particles is dₚ≦100 nm. Pigments of such relatively small dimensions yield optically transparent coatings which exhibit relatively little lightscattering. Since the low-pressure mercury vapor discharge lamp in accordance with the invention is often used in specially designed reflectors, in which the light source is embodied so as to be punctiform, light scattering by the coatings is an undesirable property. The effect of light scattering is at least substantially precluded if the average diameter of the pigment particles dₚ≦50 nm.

Particularly suitable low-pressure mercury vapor discharge lamps are obtained by applying a pigment in a coating, which pigment is composed of a mixture of iron oxide and bismuth vanadate, or of a mixture of iron oxide doped with phosphorus and bismuth vanadate.

It has been found that a low-pressure mercury vapor discharge lamp comprising a discharge vessel which is coated in accordance with the invention with a coating comprising a network obtained by conversion of an organically modified silane by means of a sol-gel process preserves its initial properties to a substantial degree during the service life of the low-pressure mercury vapor discharge lamp.

These and other aspects of the invention are apparent from and will be elucidated with reference to the embodiments described hereinafter.

In the drawings:

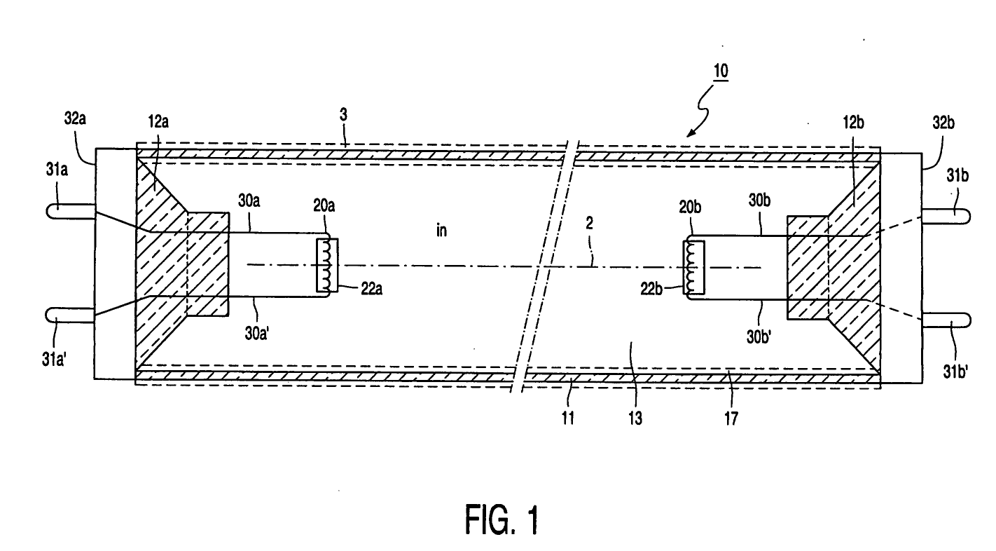

FIG. 1 is a longitudinal sectional view of an embodiment of the low-pressure mercury-vapor discharge lamp in accordance with the invention, and

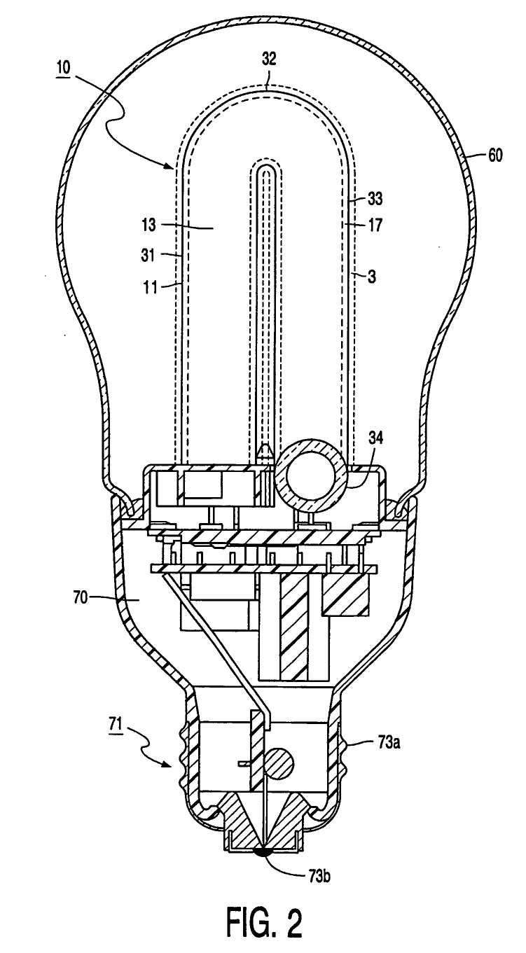

FIG. 2 is a cross-sectional view of an embodiment of a compact fluorescent lamp comprising a low-pressure mercury vapor discharge lamp according to the invention;

The Figures are purely schematic and not drawn to scale. Particularly for clarity, some dimensions are exaggerated strongly. In the Figures, like reference numerals refer to like parts whenever possible.

FIG. 1 shows a low-pressure mercury-vapor discharge lamp comprising a glass discharge vessel 10 having a tubular portion 11 surrounding a longitudinal axis 2, which discharge vessel transmits radiation generated in the discharge vessel 10 and is provided with a first and a second end portion 12a; 12b, respectively. In this example, the tubular portion 11 has a length of 120 cm and an inside diameter of 24 mm. The discharge vessel 10 encloses, in a gastight manner, a discharge space 13 containing a filling of mercury and an inert gas mixture comprising, for example, argon. The side of the tubular portion 11 facing the discharge space 13 is provided with a luminescent layer 17 which comprises a luminescent material (for example a fluorescent powder) which converts the ultraviolet (UV) light generated by fallback of the excited mercury into (generally) visible light. In an alternative embodiment, the luminescent layer is provided on an outer surface of the discharge vessel. In the example of FIG. 1, means for maintaining a discharge in the discharge space 13 are electrodes 20a; 20b arranged in the discharge space 13, said electrodes 20a; 20b being supported by the end portions 12a; 12b. The electrode 20a; 20b is a winding of tungsten covered with an electron-emitting substance, in this case a mixture of barium oxide, calcium oxide, and strontium oxide. Current-supply conductors 30a, 30a′; 30b, 30b′ of the electrodes 20a; 20b, respectively, pass through the end portions 12a; 12b and issue from the discharge vessel 10 to the exterior. The current-supply conductors 30a, 30a′; 30b, 30b′ are connected to contact pins 31a, 31a′; 31b, 31b′ which are secured to lamp caps 32a, 32b. In general, an electrode ring is arranged around each electrode 20a; 20b (not shown in FIG. 1A), on which ring a glass capsule for dispensing mercury is clamped. In the example shown in FIG. 1A, the electrode 20a; 20b is surrounded by an electrode shield 22a; 22b. Preferably, the electrode shield is made from a ceramic material comprising aluminum oxide. According to the invention, the outer surface of the discharge vessel 10 is provided with a coating 3 which comprises a pigment that absorbs part of the visible light, and/or the coating 3 comprises reflecting particles. The coating 3 comprises a network obtainable through conversion of an organically modified silane by means of a sol-gel process and preferably has an average thickness of 2-5 μm.

FIG. 2 shows a compact fluorescent lamp comprising a low-pressure mercury vapor discharge lamp. Similar components in FIG. 2 are denoted as much as possible by the same reference numerals as in FIG. 1. The low-pressure mercury-vapor discharge lamp is in this case provided with a radiation-transmitting discharge vessel 10 having a tubular portion 11 enclosing, in a gastight manner, a discharge space 13 having a volume of approximately 25 cm³. The discharge vessel 10 is a glass tube which is at least substantially circular in cross-section and the (effective) internal diameter of which is approximately 10 mm. In this example, the tubular portion 11 has a total length of approximately 40 cm. The tube is bent in the form of a so-called hook and, in this embodiment, it has a number of straight parts, two of which, referenced 31, 33, are shown in FIG. 2. The discharge vessel further comprises a number of arc-shaped parts, two of which, referenced 32, 34, are shown in FIG. 2. The side of the tubular portion 11 facing the discharge space 13 is provided with a luminescent layer 17. In a further alternative embodiment, the luminescent layer is coated with a further protective layer (not shown in FIG. 2). The discharge vessel 10 is supported by a housing 70 which also supports a lamp cap 71 provided with electrical and mechanical contacts 73a, 73b, which are known per se. In addition, the discharge vessel 10 is surrounded by a light-transmitting envelope 60 which is attached to the lamp housing 70. The light-transmitting envelope 60 generally has a matt appearance. According to the invention, the outer surface of the discharge vessel 10 is provided with a coating 3, formed by a network of a pigmented organically modified silane, by means of a sol-gel process. Preferably, the coating has an average thickness of 2-3 μm.

### EXAMPLE 1

A quantity of 10 g ZnFe₂O₄ (particle size 70 nm) is dispersed in a 50/50% water/ethanol mixture, using “disperbyk 190” as the dispersing agent. The overall weight of the mixture is 30 g. An optically clear liquid is obtained by means of wet ball milling using 2 mm zirconium oxide grains. A quantity of 3 g Fe₂O₃ (particle size 40 nm) is dispersed in a corresponding manner. A hydrolysis mixture of 40 g methyltrimethoxy silane (MTMS), 0.6 g tetraethylorthosilicate (TEOS), 32 g water, 4 g ethanol, and 0.15 g glacial acetic acid is stirred for 48 hours at room temperature and subsequently stored in a refrigerator.

A coating liquid is prepared by mixing 10 g of said ZnFe₂O₄ dispersion, 6 g of the Fe₂O₃ dispersion, and 10 g of the MTMS/TEOS hydrolysis mixture with 4 g methoxy propanol, which coating liquid is subsequently spray-coated onto the outer surface of the major portion of a discharge vessel. The coating is cured for 10 minutes at a temperature of 250° C. In this manner, a coating in a thickness of up to 3 μm is obtained on a glass discharge vessel without cracks arising during drying and curing.

A low-pressure mercury vapor discharge lamp provided with a coating manufactured as described in this embodiment is amber-colored, transparent, and free of light scattering. The coating obtained in accordance with the above recipe has a thickness of 2.7 μm. The weight fractions of the components in this coating are 52% ZnFe₂O₄ and Fe₂O₃, 18% “disperbyk 190”, and 30% MTMS. The coating is stable during the service life of the low-pressure mercury vapor discharge lamp.

### EXAMPLE 2

A quantity of 3 g BiVO₄ is dispersed in a 50/50% water/ethanol mixture, using “solsperse 41090” as the dispersing agent. The overall weight of the mixture is 23 g. A stable dispersion is obtained by means of wet ball milling with 2 mm zirconium oxide grains. A quantity of 3 g Fe₂O₃ is dispersed in a corresponding manner. A hydrolysis mixture of 40 g methyltrirethoxy silane (MTMS), 0.6 g tetraethyl orthosilicate (TEOS), 32 g water, 4 g ethanol, and 0.15 g glacial acetic acid is stirred for 48 hours at room temperature and subsequently stored in a refrigerator. A coating liquid is prepared by mixing 10 g of said BiVO₄ dispersion, 6 g of the Fe₂O₃ dispersion, and 10 g of the MTMS/TEOS hydrolysis mixture with 4 g methoxy propanol, whereafter the coating liquid is spray-coated onto the outer surface of the major portion of a discharge vessel. The coating is dried for 20 minutes at a temperature of 160° C. In this manner, a coating in a thickness of up to 3 μm is formed on a glass discharge vessel without cracks arising during drying and curing.

A low-pressure mercury vapor discharge lamp provided with a coating made in accordance with the embodiment described above is amber-colored and relatively free of light scattering, although the diameter of the bismuth-vanadate particles exceeds 100 nm.

The coating obtained in accordance with the recipe has a thickness of at least substantially 3 μm. The weight fractions of the components in this coating are 21% Fe₂O₃, 21% BiVO₄, 17% solspers, and 41% MTMS. The coating remains stable during the service life of the low-pressure mercury vapor discharge lamp.

### EXAMPLE 3

A quantity of 6 g P-doped Fe₂O₃ is dispersed in a 50/50% water/ethanol mixture, using “disperbyk 190” as the dispersing agent. The overall weight of the mixture is 32 g. A hydrolysis mixture of 40 g methyltrimethoxy silane (MTMS), 0.6 g tetraethyl orthosilicate (TEOS), 32 g water, 4 g ethanol, and 0.15 g glacial acetic acid is stirred for 48 hours at room temperature and subsequently stored in a refrigerator. A coating is prepared by mixing 20 g of the P-doped Fe₂O₃ dispersion and 7 g of the MTMS/TEOS hydrolysis mixture with 8 g methoxy propanol, and said coating liquid is subsequently spray-coated onto the outer surface of the major portion of a discharge vessel. The coating is dried for 20 minutes at a temperature of 160° C. In this manner, a coating having a thickness up to 6 μm is formed on a glass discharge vessel without cracks arising during drying and curing. The realization of such a relatively great layer thickness is possible because a relatively high concentration of pigment is used at a relatively low concentration of MTMS.

A low-pressure mercury vapor discharge lamp provided with a coating manufactured in accordance with this embodiment is red, transparent, and free of light scattering. The coating remains stable throughout the service life of the low-pressure mercury vapor discharge lamp.

### EXAMPLE 4

A pigment (for example chromophtal yellow) having an average particle size below 100 mn is dispersed in a water/ethanol mixture in the presence of “disperbyk 190” as the dispersing agent. An optically clear liquid is obtained by so-called “wet ball milling” using zirconium-oxide grains. A hydrolysis mixture is prepared by mixing methyltrimethoxysilane (MTMS), tetraethylorthosilicate (TEOS), water, ethanol, and glacial acetic acid. A mixture of the pigment dispersion and the hydrolysis mixture is used to apply a light-absorbing coating (for example 1.5-2 μm) to the lamp vessel by means of spraying. The layer is subsequently cured at 250° C. for 5-10 minutes.

A low-pressure mercury vapor discharge lamp provided with a coating manufactured in accordance with the embodiment described is a yellow transparent coating which is free of light scattering. The coating remains stable throughout the service life of the low-pressure mercury vapor discharge lamp.

### EXAMPLE 5

A reflecting coating is made from 50 g methyltrimethoxysilane, 60 g acetic acid, and 18 g H₂O. The solution is hydrolyzed for 10 minutes. A ludox TM 50 suspension (Aldrich 50 wt. % silica in water stabilized by sodium or ammonium ions) is added to make thick MTMS layers possible. TiO₂ particles coated with silica (Dupont) should be in the order of 250 nm to obtain optimal scattering properties. Alternatively, the particles may be stabilized with Dysperbyk (0.4 g Dysperbyk per gram TiO₂). The particle suspension is milled with 2 μm yttria-stabilized zirconia milling balls on a roller bench. The coating liquid is deposited on the outer surface of the discharge vessel by means of spraying. After deposition, the coating is dried at 90° C. for a few minutes and subsequently is cured for 5 minutes at 160° C.

It will be clear that many variations are possible to those skilled in the art within the scope of the invention. Many alternative preparation methods are possible in the sol-gel process. For example, the acid used for hydrolysis may alternatively be maleic acid. The color temperature of the light to be emitted by the low-pressure mercury vapor discharge lamp may be increased while, for example, the color co-ordinates remain substantially positioned on the black body locus.

The scope of protection of the invention is not limited to the examples given herein. The invention is embodied in each novel characteristic and each combination of characteristics. Reference numerals in the claims do not limit the scope of protection thereof. The use of the term “comprising” does not exclude the presence of elements other than those mentioned in the claims. The use of the word “a” or “an” before an element does not exclude the presence of a plurality of such elements.

1. A low-pressure mercury vapor discharge lamp comprising a light-transmitting discharge vessel (10),
the discharge vessel (10) enclosing, in a gastight manner, a discharge space (13) provided with a filling of mercury and a rare gas,
the discharge vessel (10) comprising means for maintaining a discharge in the discharge space (13),
at least a portion of the discharge vessel (10) being provided with a luminescent layer (17) of a luminescent material,
at least a portion of the discharge vessel (10) facing away from the discharge space (13) being provided with a coating (3),
characterized in that
the coating (3) comprises a pigment which absorbs a part of the visible or UV light and/or the coating (3) comprises reflecting particles,
the coating (3) comprises a network obtainable through conversion of an organically modified silane by means of a sol-gel process,
said organically modified silane being selected from the group formed by compounds of the following structural formula: R^{I}Si(OR^{II})₃,
wherein R^{I} represents an organic group, preferably an alkyl group or an aryl group, and
wherein R^{II} represents an alkyl group.

2. The low-pressure mercury vapor discharge lamp as claimed in claim 1, characterized in that the RI group comprises CH₃ or C₆H₅.

3. A low-pressure mercury vapor discharge lamp as claimed in claim 1, characterized in that the R^{II} group comprises CH₃ or C₂H₅.

4. A low-pressure mercury vapor discharge lamp as claimed in claim 1, characterized in that an average diameter dₚ of the pigment is dₚ≦100 nm.

5. A low-pressure mercury vapor discharge lamp as claimed in claim 1, characterized in that the thickness t_{c} of the coating (3) is t_{c}≧1 μm.

6. A low-pressure mercury vapor discharge lamp as claimed in claim 1, characterized in that silica particles having a diameter d≦50 nm are incorporated in the network.

7. A low-pressure mercury vapor discharge lamp as claimed in claim 1, characterized in that the pigment causes a change in the color temperature of the low-pressure mercury vapor discharge lamp.

8. A low-pressure mercury vapor discharge lamp as claimed in claim 1, characterized in that the pigment is selected from the group formed by iron oxide, iron oxide doped with phosphorus, zinc-iron oxide, cobalt aluminate, neodymium oxide, bismuth vanadate, zirconium praseodymium silicate, and mixtures thereof.

9. A low-pressure mercury vapor discharge lamp as claimed in claim 1, characterized in that the pigment is selected from the group formed by anthraquinone, chromium phthalic yellow, perylene, quinacridone, Ni-isoindoline, quinacridone, Cu-phthalocyanine, Cu-phthalocyanine, dyaryl, chromium phtalic red, and mixtures thereof.

10. A low-pressure mercury vapor discharge lamp as claimed in claim 1, characterized in that the reflecting particles are selected from the group formed by aluminum, silver, aluminum oxide, titanium oxide, and barium sulfate.

11. A low-pressure mercury vapor discharge lamp as claimed in claim 10, characterized in that the size of the particles is in a range from 1 to 400 nm, preferably approximately 250 nm.
